(19) United States
(12) Patent Application Publication
(10) Pub. No.: US 2008/0083015 A1
(43) Pub. Date: Apr. 3, 2008

(54) Method for unlocking a portable multimedia player and apparatus thereof

(75) Inventor: Hyun-ki Kim, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/785,122

(22) Filed: Apr. 16, 2007

(30) Foreign Application Priority Data
Oct. 2, 2006 (KR) 10-2006-0097413

(51) Int. Cl. G06F 17/30; H04L 9/32

(52) U.S. Cl. 726/2; 726/27

(57) ABSTRACT

Method and apparatus for unlocking a portable multimedia player are provided. Method of unlocking a portable multimedia player having a display unit and a plurality of direction keys, includes: outputting a maze background image on the display unit; a user inputting a maze path by using the direction keys; determining whether or not the input maze path matches a maze path preset by the user; and if the determination result indicates that the maze paths match, unlocking the portable multimedia player. The method and apparatus for unlocking a portable multimedia player use a visual maze, thereby aiding user's memory, reducing the key inputs needed, and thus increasing user convenience compared to the conventional method using a password. Also, a user input unit according to the apparatus needs only a direction key and a confirm key, thereby reducing the size and cost compared to the conventional input unit including numeric keys.

### CROSS-REFERENCE TO RELATED PATENT APPLICATIONS

This application claims the benefit of Korean Patent Application No. 10-2006-0097413, filed on Oct. 2, 2006, in the Korean Intellectual Property Office, the disclosure of which is incorporated herein in its entirety by reference.

### BACKGROUND OF THE INVENTION

1. Field of the Invention

Methods and apparatuses consistent with the present invention relate to a portable multimedia player (PMP), and more particularly, to unlocking a PMP when the PMP is in a locked state, and a PMP having the apparatus for unlocking.

2. Description of the Related Art

Conventional portable multimedia players (PMPs), such as MP3 players and digital multimedia broadcasting (DMB) receivers have a locking function to protect the privacy of a user. Accordingly, if the PMP is locked by the user, nobody can use the PMP, or certain functions or files of the PMP, without unlocking the PMP.

FIG. 1 is a diagram illustrating a conventional method of unlocking a typical locked PMP, using the example of an ‘i-Station V43’ sold by ‘DigitalCube’ and having a privacy protection program. If a user presses keys for input in order to use this PMP in a locked state, the PMP first displays a password input window on a touch screen. Then, the user inputs a numeric password using the touch screen.

However, this method of unlocking cannot be applied to a PMP that does not have a touch screen. Most input devices for PMPs have only a direction key and an enter key, and do not even include number keys or character keys, let alone a touch screen.

Accordingly, in order for a user to input a numeric password using only the direction key and enter key, many key inputs are required, thereby taking much time and causing inconvenience to the user. Also, the user may easily forget a numeric password.

### SUMMARY OF THE INVENTION

The present invention provides a method and apparatus for unlocking a portable multimedia player (PMP), which are simpler and more convenient than conventional technology, by using a maze puzzle method.

According to an aspect of the present invention, there is provided a method of unlocking a portable multimedia player (PMP) having a display unit and a plurality of direction keys, the method including: outputting a maze background image on the display unit; a user inputting a maze path by using the direction keys; determining whether or not the input maze path matches a maze path preset by the user; and if the determination result indicates that the maze paths match, unlocking the portable multimedia player.

According to another aspect of the present invention, there is provided a method of performing a function of an apparatus comprising a display unit and a plurality of direction keys, the method including: receiving an input of the direction keys; displaying at least one path corresponding to the input direction key, on a display unit; determining whether or not the input path on the display unit matches a preset path; and if the paths match, performing the function.

According to another aspect of the present invention, there is provided a computer readable recording medium having embodied thereon a computer program for executing a method of unlocking a PMP having a display unit and a plurality of direction keys, wherein the method includes: outputting a maze background image on the display unit; a user inputting a maze path by using the direction keys; determining whether or not the input maze path matches a maze path preset by the user; and if the determination result indicates that the maze paths match, unlocking the portable multimedia player.

### BRIEF DESCRIPTION OF THE DRAWINGS

The above and other features and aspects of the present invention will become more apparent by describing in detail exemplary embodiments thereof with reference to the attached drawings in which:

FIG. 1 shows a conventional method of unlocking a portable multimedia player (PMP);

FIGS. 2A-2D show an example 6f a method and apparatus of unlocking a PMP according to an exemplary embodiment of the present invention;

FIG. 3 shows the relationship between 4 direction keys of an apparatus for unlocking a PMP and a maze path according to an exemplary embodiment of the present invention;

FIG. 4 is a flowchart illustrating a method of unlocking a PMP according to an exemplary embodiment of the present invention;

FIG. 5 is a flowchart illustrating a method of unlocking a PMP according to another exemplary embodiment of the present invention;

FIG. 6 is a functional block diagram of an apparatus for unlocking a PMP according to an exemplary embodiment of the present invention; and

FIGS. 7A-7C and 8A-8D show maze background images and examples of entire maze paths that can be preset by a user according to an exemplary embodiment of the present invention;

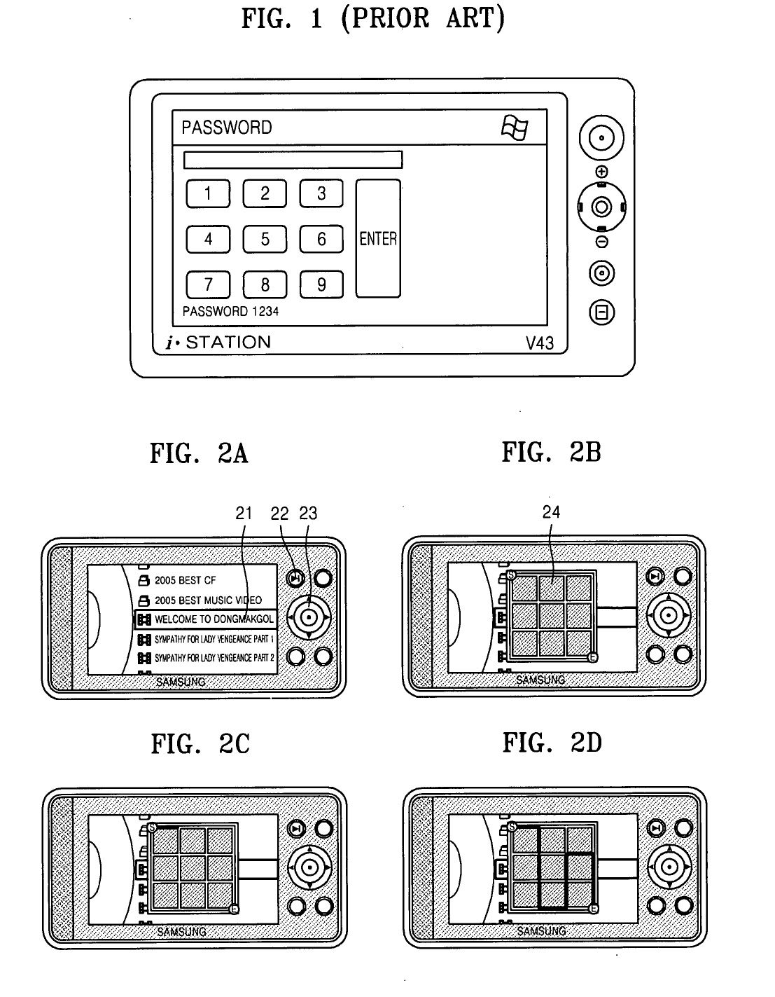

### DETAILED DESCRIPTION OF THE INVENTION

The present invention will now be described more fully with reference to the accompanying drawings, in which exemplary embodiments of the invention are shown.

The types of locking functions provided by a portable multimedia player (PMP) according to the present invention include a usage locking (or restriction) function for preventing use of the PMP itself, a function locking function for preventing use of certain functions of the PMP, and a file locking function for preventing use of certain files stored in the PMP. However, for convenience of explanation, the description below will focus mainly on a method and apparatus for unlocking a file.

FIG. 2 shows an example of a method and apparatus of unlocking a PMP according to an exemplary embodiment of the present invention.

First, a user sets a desired maze path and stores the path in advance. If the user selects a movie file 21 by using 4 direction keys 23 in order to view the movie and then presses a play button 22, the PMP determines whether or not the file is locked, and if the file is locked, a maze background image 24 is displayed on a display unit. The user inputs a maze path by using the 4 direction keys 23. According to the key input by the user, a maze path is displayed from a start point (S) to an end point (E) as thick lines on the maze background image. If the input maze path matches the preset and/or stored maze path, the file of the PMP is unlocked and the movie file is played. In FIG. 2A-2D, the start point (S) is at the upper left corner of the maze background image 24 and the end point (E) is at the lower right corner of the maze background image 24. In another embodiment, the start point (S) and the end point (E) are disposed at different locations on the maze background image 24.

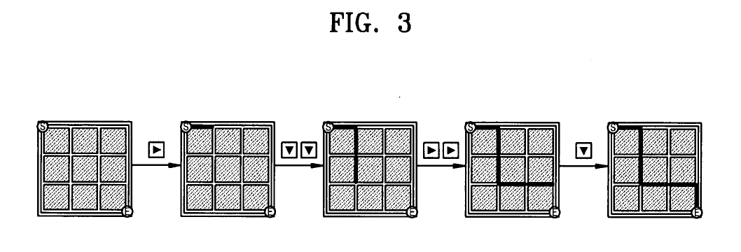

FIG. 3 shows the relationship between 4 direction keys of an apparatus for unlocking a PMP and a maze path according to an exemplary embodiment of the present invention.

The entire maze path (from S to E) is formed of a plurality of sections of a maze path. Here, each section is a part of the maze path traversed by one key input. For example, in FIG. 3, the entire maze path is formed of six maze path sections, and requires six key inputs.

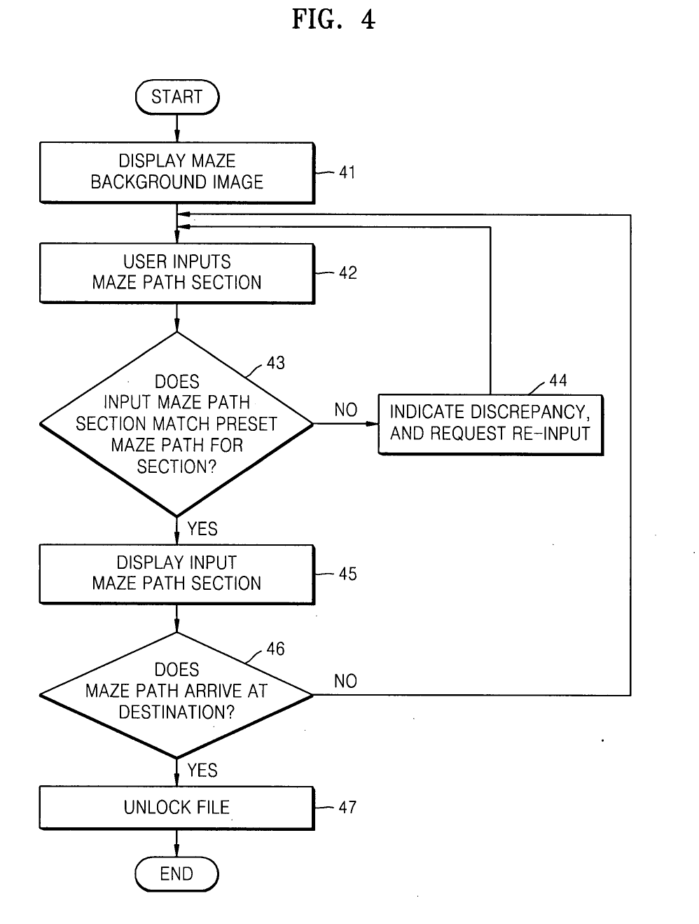

FIG. 4 is a flowchart illustrating a method of unlocking a PMP according to an exemplary embodiment of the present invention.

First, if a locked file is selected to be played, a maze background image is displayed on the display unit of the PMP in operation 41.

The user inputs a maze path section by using 4 direction keys in operation 42.

It is determined whether or not the maze path section input in operation 42 matches the preset maze path for the section in operation 43.

Operations 42 and 43 are repeatedly performed for each maze path section of the entire maze. That is, whenever the user makes a key input, the maze path section is compared with the preset maze path for that section, thereby determining whether or not the maze paths match.

If the determination result in operation 43 indicates that the input maze path section does not match the preset maze path for that section, the discrepancy, i.e., the mismatch, is indicated to the user, and the user is requested to re-input a maze path section in operation 44, then operation 42 is performed again.

If the determination result in operation 43 indicates the input maze path section matches the preset maze path for that section, the maze path section is displayed on the maze background image in operation 45.

It is determined whether or not the maze path input by the user arrives at the end (E) in operation 46. If the determination result in operation 46 indicates that the maze path does not arrive at the end (E), operation 42 is performed again so that the user can input a new maze path section. However, if the maze path arrives at the end (E), the input of a maze path is finished and the file is unlocked in operation 47, thereby beginning playback of the file.

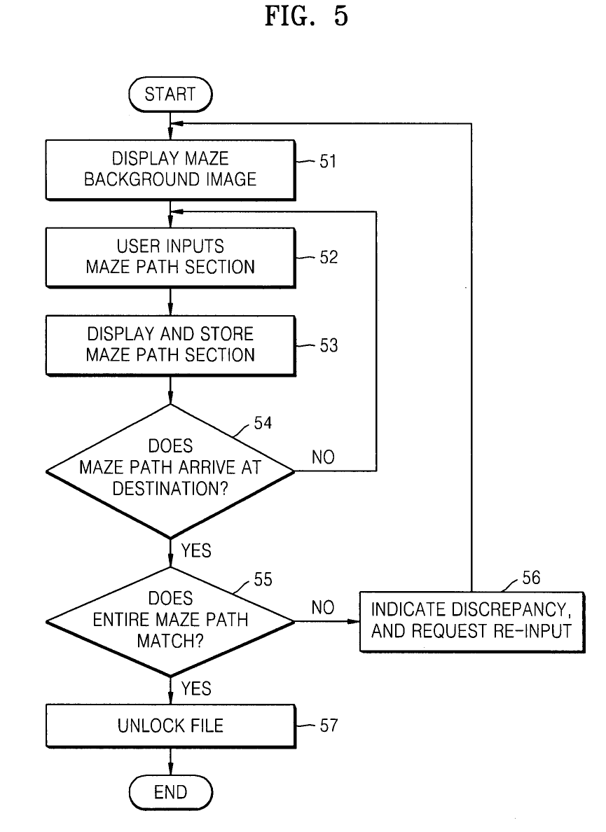

FIG. 5 is a flowchart illustrating a method of unlocking a PMP according to another exemplary embodiment of the present invention.

First, if a locked file is selected to be played, a maze background image is displayed on the display unit of the PMP in operation 51.

The user inputs a maze path section by using 4 direction keys in operation 52.

The input maze path section is displayed on the maze background image and stored in the storage unit 64 of the PMP in operation 53.

Operations 52 and 53 are repeatedly performed for each maze path section of the entire maze. That is, whenever the user makes a key input, the maze path section is displayed on the maze background image and stored in the storage unit 64.

It is determined whether or not the maze path input by the user arrives at the end (E) in operation 54. If the determination result in operation 54 indicates that the maze path does not arrive at the end (E), operation 52 is performed again so that the user can input a new maze path section. However, if the maze path arrives at the end (E), operation 55 is performed.

In operation 55, it is determined whether or not the maze path stored in operation 53 matches the entire preset maze path.

If the determination result in operation 55 indicates that the entire maze paths do not match, the discrepancy is indicated to the user, the user is requested to re-input a maze path, and operation 51 is performed again. If the determination result in operation 55 indicates that the entire maze paths match, the file is unlocked in operation 57, thereby beginning playback of the file.

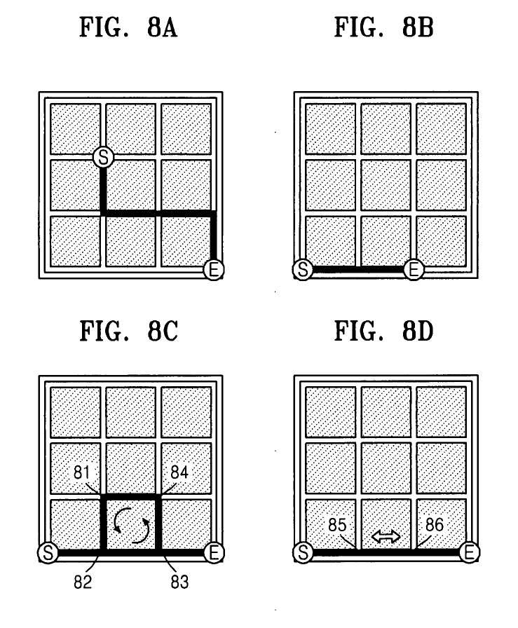

FIG. 7 shows a maze background image and examples of maze paths that can be preset by a user according to an exemplary embodiment of the present invention. The maze background image illustrated in FIG. 7 has a grid pattern. This is only one exemplary embodiment of the present invention, and the maze background image may have other shapes, such as other polygons or shapes of things. The maze path illustrated in FIG. 7A has a ‘ [symbol] shape, which is a Korean letter, and the maze path illustrated in FIG. 7B has a ‘L’ shape, which is a Latin alphabet letter. The maze path illustrated in FIG. 7C has a shape similar to Arabic numeral ‘2’. In these examples, the maze path is set to have a shape similar to a character or symbol, thereby allowing the user to easily remember the maze path. In each of FIGS. 7A through 7C, the start point (S) is at the top left corner and the end point (E) is at the bottom right corner. However, as illustrated in FIG. 8, the start point (S) and the end point (E) may be placed at arbitrary positions on the maze background image according to the selection of the user. Also, the maze path may be designed such that a section on the maze background image is repeatedly traversed in the unlocking path, or a path which is already included in the unlocking path is traversed again in the reverse direction. For example, in FIG. 8C, the unlocking maze path includes a square path (81-82-83-84) traversed one or more times. In FIG. 8D, the unlocking maze path includes a straight line path (85-86) traversed more than once.

In FIGS. 4 and 5, when the user inputs an exact maze path, the file is unlocked in operations 47 and 57, and the unlocking procedure according to the exemplary embodiments of the present invention finishes. However, in another exemplary embodiment of the present invention, even before operation 47 or 57, if the user presses a ‘cancel’ button for input, or if the user does not press any key for a predetermined time, the unlocking procedure of the PMP is finished (time out). The predetermined time may be selected freely by the designer or user (e.g. 5 seconds, 10 seconds, 1 minute, etc.).

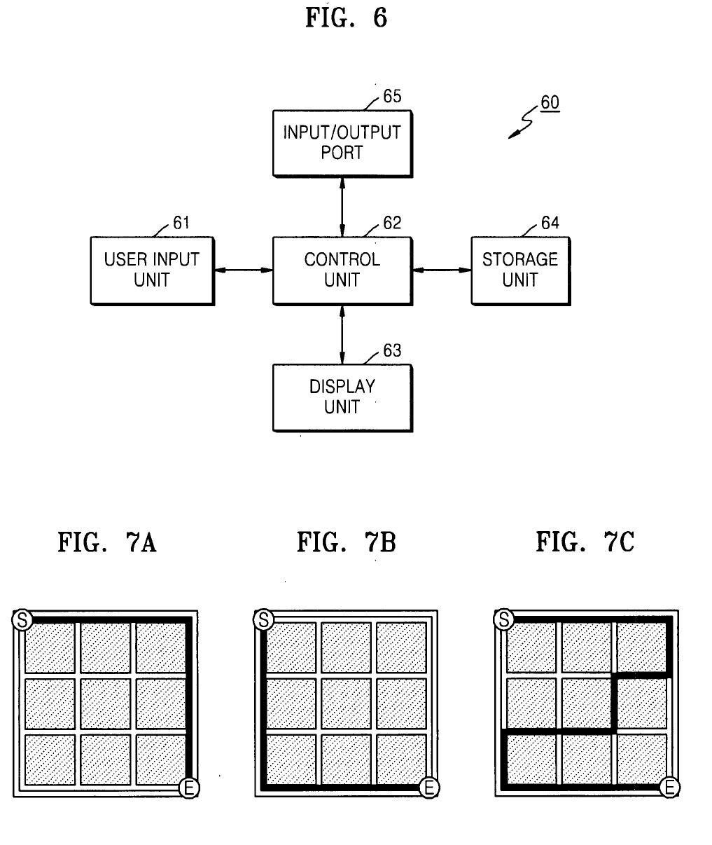

FIG. 6 is a functional block diagram of an apparatus for unlocking a PMP according to an exemplary embodiment of the present invention.

A storage unit 64 stores multimedia files downloaded from external PCs or a variety of firmware and other programs required for operating the PMP. In particular, in the present invention, the storage unit 64 stores a maze background image and an entire maze path preset by the user.

An input/output port 65 is a connection device, such as a USB port, for uploading or downloading files to or from an external PC.

A user input unit 61 is formed of a plurality of direction keys (2, 4, 6 direction keys, etc.), buttons, and a touch pad, and is used in order for a user to select a file or function of the PMP or to input a maze path.

A display unit 63 is formed of a liquid crystal display (LCD), and outputs an image signal processed by the PMP. In particular, in the present invention, a maze background image and a maze path input by the user are displayed.

A control unit 62 is formed with a codec unit for decoding a variety of multimedia files (MP3, WMA, OGG, etc.), an audio codec for converting a digital signal into an analog signal, an input/output port control unit, and a power control unit. The control unit 62 compares a maze path input by a user with a maze path preset by the user, and if the paths match, the control unit 62 unlocks the PMP.

As described above, the method and apparatus for unlocking a portable multimedia player use a visual maze, thereby helping a user to remember it, reducing the key inputs needed, and thus increasing user convenience when compared to the conventional method using a password. Also, a user input unit according to the present invention needs only a direction key and a enter key, thereby reducing the size and cost compared to the conventional input unit including numeric keys.

The present invention can also be embodied as computer readable code on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

While the present invention has been particularly shown and described with reference to exemplary embodiments thereof, it will be understood by those of ordinary skill in the art that various changes in form and detail may be made therein without departing from the spirit and scope of the present invention as defined by the following claims. The exemplary embodiments should be considered in a descriptive sense only and not for purposes of limitation. Therefore, the scope of the invention is defined not by the detailed description of the invention but by the appended claims, and all differences within the scope will be construed as being included in the present invention.

What is claimed is:

1. A method of performing a function of an apparatus comprising a display unit and a plurality of direction keys, the method comprising:
receiving an input of the plurality of direction keys;
displaying at least one path section corresponding to the input of the plurality of direction keys, on a display unit;
determining whether or not the at least one path section on the display unit matches a corresponding section of a preset path; and
if the path section matches the corresponding section of the preset path, performing the function.

2. The method of claim 1, further comprising displaying a background image.

3. The method of claim 2, wherein the background image comprises a maze.

4. The method of claim 1, further comprising setting the apparatus to a locked state.

5. A method of unlocking a portable multimedia player (PMP) having a display unit and a plurality of direction keys, the method comprising:
displaying a maze background image on the display unit;
inputting a maze path by using at least one of the plurality of direction keys;
determining whether or not the input maze path matches a maze path preset by a user to generate a determination result; and
if the determination result indicates that the input maze path matches the maze path preset by the user, unlocking the PMP.

6. The method of claim 5, further comprising, if the determination result indicates that the input maze path does not match the maze path preset by the user, indicating to the user a mismatch of the input maze path and the maze path preset by the user, and requesting the user to re-input another maze path.

7. The method of claim 5, wherein the inputting of the maze path by using the at least one of the plurality of direction keys comprises inputting a maze path section, and
the determining of whether or not the input maze path matches the maze path preset by the user comprises determining whether the maze path section matches a corresponding section of the maze path preset by the user.

8. The method of claim 5, wherein the inputting of the maze path by using the at least one of the plurality of direction keys comprises inputting an entire maze path, and
the determining of whether or not the input maze path matches the maze path preset by the user comprises determining whether or not the input entire maze path matches an entire maze path preset by the user.

9. The method of claim 5, wherein the user selects arbitrary points on the maze background image as a start point of the input maze path and an end point of the input maze path.

10. The method of claim 5, further comprising:
setting the PMP to a locked state in advance; and
setting an entire maze path.

11. The method of claim 10, wherein in the setting of the PMP to the locked state, the locked state restricts a use of the PMP.

12. The method of claim 10, wherein in the setting of the PMP to the locked state, a file is locked.

13. The method of claim 10, wherein in the setting of the PMP to the locked state, a function of the PMP is locked.

14. An apparatus having a display unit and a plurality of direction keys, the apparatus comprising:
a direction key input reception unit which receives an input signal of a direction key of the plurality of direction keys from a user;
a display unit which displays a path corresponding to the input signal of the direction key;
a storage unit which stores a preset entire path that can be compared with the displayed path; and
a control unit which determines whether or not the path corresponding to the input signal matches the stored preset entire path and which, if the path corresponding to the input signal matches the stored preset entire path, performs a predetermined function.

15. An apparatus for unlocking a portable multimedia player (PMP) capable of reproducing voice and image files, the apparatus comprising:
a storage unit which stores a maze background image and an entire maze path preset by a user;
a user input unit comprising direction keys which receives a user input of a user maze path;
a display unit which displays the maze background image and the user maze path; and
a control unit which determines whether or not the user maze path input by the user matches the entire maze path preset by the user, and which, if the user maze path matches the entire maze path preset by the user, unlocking the PMP.

16. The apparatus of claim 15, wherein the maze background is formed of a plurality of polygons.

17. The apparatus of claim 15, wherein the maze path comprises any one shape of a letter, a symbol, and a number.

18. A portable multimedia player (PMP) comprising the apparatus of claim 15.

19. A computer readable recording medium having embodied thereon a computer program for executing a method of unlocking a portable multimedia player (PMP) comprising a display unit and a plurality of direction keys, wherein the method comprises:
displaying a maze background image on the display unit;
inputting a maze path by using at least one of the plurality of direction keys;
determining whether or not the input maze path matches a maze path preset by the user to generate a determination result; and
if the determination result indicates that the input maze path matches the maze path preset by the user, unlocking the PMP.
